(19) United States
(12) Patent Application Publication
(10) Pub. No.: US 2012/0215898 A1
(43) Pub. Date: Aug. 23, 2012

(54) Applications of a Network-Centric Information Distribution Platform on the Internet

(76) Inventors: Nitin Jayant Shah, Cupertino, CA (US); David Milton Becker, Croton on Hudson, NY (US)

(21) Appl. No.: 13/398,664

(22) Filed: Feb. 16, 2012

Related U.S. Application Data
(60) Provisional application No. 61/463,355, filed on Feb. 17, 2011.

(51) Int. Cl. G06F 15/173

(52) U.S. Cl. 709/223

(57) ABSTRACT

The predominant way of customizing and tailoring services on the Internet is the use of cookies. The invention in this disclosure is to use the http header in an http get request as a distribution mechanism of anonymized and unique metadata between the user and the web server, and then for the web server to interrogate an information storage system hosted in the cloud or in a server to get real-time information, classification, categorization of that device in real time. The invention allows the web server to customize the service for that particular session using that information. This two-tiered distribution platform on the internet can be used for a wide range of applications such as advertising, security, authentication, emergency altering, children's privacy in a reliable, robust and trust-worthy way compared to the use of cookies, and the invention is universal and works with any Internet connected device.

### CROSS REFERENCE TO RELATED APPLICATIONS

The present application claims the benefit of the U.S. Provisional Application No. 61/463,355 entitled “Applications of a Network-Centric Information Distribution Platform on the Internet” and filed on Feb. 17, 2011.

### BACKGROUND OF THE INVENTION

1. Technological Field

2. Description of the Related Art

The present invention relates to the distribution of information about various attributes of a user on an Internet connection to permit the user and the provider of internet services to manage and customize the service offered to that user or category of user.

Today the most universal means of distributing data for metrics and targeting and verification of the user or the device or the browser on the web is the cookie. Various other tools such as the flash cookies, IP address or device profiling and fingerprinting with certain combination of attributes of a devices have also been used to create a unique or persistent identifiers, including the Facebook beacon, for example. Other techniques such as a toolbar with a unique identifier, or what in the industry is referred to malware or spyware have also been used to both track and identify a device.

All these tools have been used to develop processes to provide behavioral targeting, re-targeting, and segmentation of users on the internet by geographic, demographic, psychographic, technographic, sociographic and other attributes which are of use to marketers. These tools are also used to impose policies or to develop compliance procedures to meet either regulated requirements or guidelines, or in some cases policies that are imposed by enterprises to control use, access and priorities for a user.

The currency for distribution of user information and tracking data on the web is the cookie, where the interaction is between a browser in the consumer device and a web-server at a publisher. Others have used TCP options and http headers to convey data from a device to a web server. In all cases, each of these implementations have come under scrutiny because of their implications on consumer privacy, and the ability of entities on the Internet to track and monitor the activity and identity of a user, without the conscious knowledge or permission of the user.

The fundamental challenge is to provide an anonymous identifier, and even more so, given the changing face of the Internet where people do want to be tracked but only in certain circumstances (defined for example not only by which websites or applications they use, but time of day, location, or before or after certain critical events). The capabilities and use of cookies and other tools today do not allow for tiers of control and shades of grey, and a hierarchy of applications which are under the control of the consumer and the business or enterprise that is managing the experience for the consumer.

This requires a technical approach which puts consumer choice at the top of the requirements, an exceptionally flexible framework for creating dynamic consumer choice, an active and visible mechanism for notifying the consumer of what is the state of the tracking (i.e. being tracked, not being tracked), or being tracked in a safe environment defined either by the consumer or by an entity that had been entrusted by the consumer to manage and actively define the trusted environment that is created by the permissions and policies of that trusted entity.

As the media, marketing and machine-to-machine and enterprise, cloud and emergency altering and public safety and smart-grid industries rely more and more on these tools, the gaps are apparent: fragmentation of mobile devices, challenges from regulators regarding tracking, consumer privacy and choice, and increasing demands from media, cloud, businesses and governmental agencies for reliable ways of distributing information from the device and network to web-based systems that can utilize that information.

### BRIEF SUMMARY OF THE INVENTION

The invention describes a network centric information distribution platform that can be used for fixed and mobile devices for a variety of applications.

The innovation is to utilize the service provider network and/or the consumer device under control of the network as a new mechanism for distribution of information, overcoming the limitations of cookies, IP addresses and dependency on browsers and fragmentation of mobile devices. In addition, information from the consumer and the network is used to deliver reliable and high quality information services at scale across publishers in a uniform protocol that can be used by any content provider or search engine for targeting and metrics.

The innovation is to develop a new network-centric tool that supersedes or complements the traditions tools for information distribution, which is less fragmented, more universal and more versatile than any of the existing systems. It should be noted that the invention also covers the use of the same overall architecture and protocol when the metadata insertion is carried out in the device not solely in the network, or initiated by the user and inserted in the device, as an additional potential implementation for some of the applications.

The solution is a value-added service for network equipment providers who currently sell switches, routers and servers, and a value add to the companies that manage the devices and machines that are connected to the Internet.

The result is a series of applications of the invention to many different functions on the Internet, including, among others:

a trusted and reliable mechanism for following consumer choice for opt-in/opt-out and do not track policies, including augmented capabilities to allow a trusted party to offer the choice of tracking on safe publisher and e-commerce sites

network-centric verification of device identity, including application to content delivery networks, to assure that content is provided only to those entities who are authorized and verified to receive the content across different devices such as smartphones, tablets, laptops, PCs, and TVs

Distribution of targeting data, market intelligence and metrics to digital advertisers and publishers, online advertising and metrics,

Management of traffic between different classes of users (including machines as well as people) inside an enterprise which may have one or more locations, and the destinations that they can communicate with, including other people inside or outside the enterprise, other machines inside and outside the enterprise and also controlled access to web content and applications and services based on the policies and compliance requirements of the enterprise

Application of the technology to SmartGrid applications: SmartGrid covers a vast range of end point devices such as meter reading and remote sensing devices at various points in the electricity and other utility distribution grid,

Trusted services based on a level of permission and protection which is managed as an added level of security and trust in cloud-based services, where not only at the commencement of a session, but either periodically or at certain trigger events, the client device is challenged, and invokes the addition of metadata to its traffic inside the network to provide a secondary and reliable way of assuring that the client device is legitimately using the cloud service.

A means of measuring, monitoring, and detecting threats from cybercriminals on an Internet network, by the active involvement of a mobile or fixed service provider network, where metadata is injected at the on-ramps of the internet, and any anomalous traffic detected in the path of the traffic or at strategically placed servers in the network can probe the network for these metadata.

### BRIEF DESCRIPTION OF DRAWING

FIG. 1 “END TO END ARCHITECTURE” is an end to end architectural figure of all the network elements and processes that are described in the invention.

### DETAILED DESCRIPTION OF THE INVENTION

The invention is based on the use of a network-centric information distribution platform on the Internet.

Despite continued innovation in targeting, metrics, behavioral, social media based on these legacy tools, this approach is to break away from the existing trajectory and introduce a fundamentally new tool into the industry.

The basic concept is that instead of using the transport network of an internet service provider as a “dumb pipe” for the transmission of information that is used by “over the top” service providers, additional capabilities inside the network have the ability to create a universal, trusted, privacy-compliant and scalable solution for the distribution of any form of segmentation data from the on-ramps of the Internet (wired or wireless) to the many destinations on the internet (i.e. publishers, ad-servers, metrics, search, content, emergency alerting, even-driven, geofencing, e-commerce, social media, security, enterprise networks, SmartGrid or cloud-based services etc).

This invention also applies to any form of fixed or mobile devices which connect over the Internet, including computers, tablets, smartphones, mobile phones with and without browsers, and machines that generate information and traffic using the Internet protocols, including RFID, SmartMeters (on a SmartGrid) and remote sensing devices.

Due to the variety of operating systems, versions of different types of devices, variations of different browsers, and development of applications which do not rely on a browser (e.g. Android or iPhone Apps), there is a lack of universality on how mobile devices are addressed compared to browsers, which have a level of commonality in traditional computing devices connected to the internet.

In addition, expression of consumer choice for tracking, opt-in/out etc is more difficult on small devices, compared to a portal.

In addition, when users use the same device (laptop or a tablet computer like an iPad) for both consumer and personal applications and for proprietary and business applications, the device itself is the same, but the usage is tiered into two or more avatars or personalities, and these need to be managed (for access, permissions, geo-fencing of services and different tiers or connectivity and permissions and compliance with corporate or governmental or industry regulations for the professional industry of the user, e.g. a person in the financial or healthcare industry).

The invention applies to Internet Networks and Access Modes, Consumer High Speed Internet including, among others, DSL, ADSL, PON, Fiber, Cable, coax cable, satellite etc Enterprise High Speed Internet including among others, DSL, ADSL, PON, Fiber, Cable, coax cable, satellite etc. Mobile and Wireless including among others 2G, 3G, 4G, WiFi, WiMAX, zigbee etc

Handover between wireless networks, and in some instances handover between fixed and mobile networks by the same user or the dame device, referred to as heterogeneous networks.

IPTV such as U-Verse/FIOS and other IPTV delivery systems, including satellite based systems

Local and short distance networks, including zigbee, NFC, Bluetooth, WiFi and other types of wired and wireless networking

Cross-platform (triple-play networks: i.e. networks which are owned by a single service provider which has the Imp tagging capability built into each of the three individual network types such as mobile, DSL, IPTV and WiFi) so the metadata is created independently in each network. This implementation means that when the metadata is received by a destination webserver,

Machine to machine networks where the communications at either one or both ends of a communications link is under the control of a machine rather than a person.

The specific focus of this invention is the applications and use cases of such a network-centric distribution system, as applied to the online content, advertising, authentication, verification, security and identity management applications on wired and wireless networks, and on a variety of internet-connected devices, and a variety of services including those launched by a browser, but also cloud-based services, applications which may or may not use a browser, and other classes of consumer and enterprise services on the Internet.

The invention consists of a platform for distribution of verification and targeting information between the on-ramps to the Internet (i.e. mobile and broadband) to their destinations (i.e. publishers and advertisers) in a trusted and secure format with the full knowledge and consent of the consumer.

The invention also encompasses incorporation of metadata in the same place and with the same protocol if it is inserted in the client device or in the browser or application, and if, for example, it is then linked to the same control systems and information formats as used for the network-based metadata insertion: i.e. certain types of information may originate from the client device and still be covered by this invention.

The invention has many use cases for generating revenues and value-creation from the Network-Centric information Distribution Platform (NCDP) that one skilled in the art can also derive, but in cases the common theme in all the use cases is a trusted network-centric platform to provide privacy safeguards, a repository of information, segmentation, classification data that is derived in real-time and non-real-time, and is available to any webserver that is able to present the right security credentials and the metadata corresponding to the specific user or machine or device attempting to access a particular service from a webserver during that specific internet session.

The invention is implemented with software in the service provider routers or servers or enterprise routers and servers to embed encrypted and anonymized metadata in the outgoing http get request of the internet traffic: this may be implemented at an access point, or at an aggregation device, or even at a DNS server or content delivery network: the principal requirement is for the entity that is adding the metadata to the datastream to be “subscriber-aware” i.e. that it has unique knowledge of the device through the use of DHCP or AAA Radius or Diameter protocols or their equivalent, even as simple as a MAC address or IP address, to ensure that the subscriber data and metadata are unambiguously matched up in the http traffic stream.

It is important to note that the server or router or switch implementation can be done in a consumer Internet service architecture or in an enterprise architecture, in the egress of the enterprise, and/or an intermediate server or switch or router, or in the destination server or router or switch: this implies in the enterprise context that the device is not confined to a user using a browser on a consumer broadband network, but could be an office worker inside an enterprise communicating via email or messaging, or a browser or a cloud based service where the application is managed in a cloud not inside the enterprise.

The invention can also be implemented with software in the browser, applications or widgets in the consumer device or machine to embed encrypted and anonymized metadata in the outgoing http get request of the internet traffic: the principal requirement is for the entity that is adding the metadata to the datastream to be “subscriber-aware” i.e. that it has unique knowledge of the device through the use of DHCP or AAA Radius or Diameter protocols or their equivalent, even as simple as a MAC address or IP address, to ensure that the subscriber data and metadata are unambiguously matched up in the http traffic stream.

The information for each user or machine or device or combinations thereof are stored in one or more cloud-based database with defined real-time interfaces for verification, targeting and audience intelligence for advertisers and publishers: this is a secured database which two essential components: inputs which are generated

privacy and consumer choice interface for the consumer to determine preferences, including opt-in/opt-out preferences, consumer education: for example, the framework provides the means for a subscriber to opt-in to allow commercial transaction to be authorized, but perhaps not allow subscribers to opt-out of fraud prevention, and ability of the consumer to manage, change, inspect and change their permissions profile from multiple devices (i.e. Internet, mobile, etc) in the same way as a remote control allows multiple options to be exercised

targeting data and information ingestion from multiple sources (consumer generated information, network, marketing data) and refinement and analytics of data for market segmentation: a tool is supplied to the owner of the server or appliance or router or switch (i.e. the service provider or the enterprise) that creates both the metadata for the insertion in the traffic stream as well as the replicated anonymized identifier that is used to re-index the actual information associated with the individual user and session with the verification or targeting data that is the useful data for the user

metrics and reporting and management tools to support customer billing and accounting including defined policies for permissible uses of subscriber or line data (for example, for fraud prevention and ID verification) and possible indexing to existing regulation sets, and incorporation of Data retention rules and policies, as well as rules about the licensing of the data to the Internet destinations that use the data, and the Audit elements and procedures, Certification requirements and service marketing restriction and stratification of information exchange protocols into appropriate NIST levels of Assurance or compliance requirements for HIPPA or financial institutions

Metadata contains certificates (analogous to PKI solutions) which are transported in the http header protocol, with sufficient credentials and encryption to ensure that the certificates can only be decoded by permitted parties. Further, what is transported between user and destination is only an instantaneously composed time-stamped and encrypted version of metadata which is an indexing/token mechanism for the certificate (i.e. not the certificate itself), so a casual detector of the certificates would not be able to decode the certificates without access to the secure database that stores the information

The database that can be accessed by any web service is implemented with a platform for distribution of verification and targeting information between the on-ramps to the Internet (i.e. mobile and broadband) to their destinations (i.e. publishers and advertisers) in a trusted and secure format with the full knowledge and consent of the consumer.

The invention applies to any form of transport for Internet traffic, including mobile networks, where a user may move from different parts of an access network, during mobility and handover, and where the data associated with the user may be constantly updated and changing dynamically due to the changing location and context of the user, and in certain instances when handover is between fixed and mobile networks, or a session is carried across a mobile, fixed Internet or a fixed IPTV network, where the common elements are the Internet protocol and the ability to manage a trusted distribution system for metadata associated with certain valuable forms of data in a secure and reliable way.

These and other embodiments are more fully described and their principles of operation explained in the following sections.

One application of the invention is for a trusted and reliable mechanism for following consumer choice for opt-in/opt-out and do not track policies, including augmented capabilities to allow a trusted party to offer the choice of tracking on safe publisher and e-commerce sites

The digital advertising industry is under scrutiny by the FTC for not providing consumer choice, most widely discussed in the FTC report referred to the “do not track” report. In reality, search, behavioral targeting and use of IP addresses are widely used to improve the performance of marketing to large numbers of Internet users, and not to deliberately identify specific individuals or to utilize any personally identifiable information.

The focus of “do not track” technology has been various ways to implement new browser capabilities to allow the consumer to have more control. Each of these tools is under attack by two competing forces, regulators question the privacy and consumer education, choice and control while marketers require reliable and actionable information about their audience

Instead of a browser/cookie based “do not track” implementation, we have developed a network-centric (mobile and broadband) approach for an end to end information distribution solution.

Consumer choice is expressed on a portal that captures the consumer's preferences. The implementation uses a novel approaches with tagging/metadata in the http traffic in software that resides in an ISP or mobile network.

This creates a robust and verifiable scheme to inform the destination website/publisher of the consumer's intent, and provides the consumer notice, choice, transparency and real-time indication of tracking status.

This also overcomes fragmentation of different browser versions and implementations,

Especially on mobile devices many of which do not have full browsers, and it also works with applications and services which do not invoke the use of a browser.

This overcomes the issue of inadvertent deletion of the NAI opt-out cookie, as there is no cookie or client software required on the consumer device.

In addition to providing a simple yes/no capability in a secure and reliable manner to the consumer, where the consumer may change their preference as desired, the control over the tracking can be done for multiple devices on a portal (e.g. DSL connection, mobile phone, mobile tablet, IPTV etc) or for example, for the DSL connection from a mobile phone. In this way the consumer not only had a reliable choice, but is also controllable dynamically as desired.

In addition, in addition to the simple choice between track or do not track, there are other capabilities which are part of this invention: this is important, as the Internet has many services and sites and applications where the consumer may desire to be tracked by those particular sites, and wants to selectively choose between sites, ad networks, metrics companies and other entities that are permitted to track the user, and not others.

At a simple level, this means that the consumer could potentially choose site by site to be tracked, for example, by certain specific news sites, but not by all other sites. In reality, the complexity of this is difficult for a consumer to manage. Further, given the dynamic way the web is evolving, distinguishing a blogging site and a news site, or knowing that a particular news site is not following policies that the consumer is aware assuming they are (due to the complexity of privacy policies and data retention practices and data sharing practices of many publishers) there is a need for an expert and trusted entity for the consumer to entrust making its choices.

In this case, in addition to the consumer choice of track or do not track, the invention is to offer another set of choices (illustrated below) where one or more trusted entities which will segment the Internet experience into communities and experiences and contexts.

This allows the consumer to allow that entity to inspect, set policies, set enforcement guidelines for publishers who use 1^{st} and 3^{rd} party cookies or other tracking schemes such as device fingerprinting, IP addresses or flash cookies and present to the consumer a very simple user interface for them to choose to visit trusted sites and allows any forms of tracking, and to prevent other sites from tracking that use or device.

The invention also allows for the consumer or device to be notified of the state of its own classification by the database and metadata held in the network: one example of notification to a consumer is with the red/amber/green notification lights, where the color coding represents the chosen state of choices on that particular website in a browser or an application or a game on a smartphone.

In one version of the invention, the consumer can click on those indicator lights and instantaneously and temporarily change the settings of the data for that session or for a period of time, to over-rule the network-based data.

One application of the invention is for a network-centric verification of device identity, including application to content delivery networks, to assure that content is provided only to those entities that are authorized and verified to receive the content.

Today, TV Everywhere is managed by username and password, which is crude and subject to fraudulent use, and therefore consumption of licensed content illicitly by consumers and pirating

Authentication/Security: similar to the implementation of a consumer choice for tracking or user preferences, but tailored specifically to the application of content management based on franchise, geo-fencing, license and royalty agreements and content distribution rights which have to be enforced for many types of entertainment and commercial content.

The consumer can go to a portal or use a mobile device to indicate its identity. The communications service provider can authenticate the user and device, and create information in the metadata that is inserted in the http get request traffic of the user, so when the user accesses certain content from a web server, the web server is able to detect whether that device is authorized.

This could be done in the metadata in the http traffic, but is better performed in the real time data delivery system, as then the permissions to receive licensed content (such as a movie, music or a sports broadcast that is normally only broadcast in certain regions) are managed and cannot be spoofed or be fraudulently generated by an unauthorized party.

In addition to the control, since websites or portals or publishers or search engines that are deemed by the consumer or the combination of the choices made by the consumer with the trusted third party which is enforcing the choices of the consumer with those internet destinations, the website itself, since it is actively receiving the metadata, can also display for the consumer whether the consumer is being tracked.

This could, for example, be done with different color-coded symbols on the publisher's site, or within the browser or application of the user, so the consumer is fully aware dynamically whether it is being tracked, and whether the tracking is due to a track/do-not-track choice, or a choice that has been entrusted to the trusted third party, which is enforcing the consumer choices.

This allows the consumer the ability to monitor and if required, override the prior choices, if they deem that they need increased control over their web experience.

This approach allows for: Multi-tiered authentication of user, based on location, device, context and other attributes that are provided in the policy management system of the content owner or distributer

Management of TV/Sports franchise area restrictions using geo-fencing, to prevent consumption of that content in forbidden media or regions

As an additional capability, this feature can also be used to detect and prevent click-fraud prevention

One application of the invention is for the distribution of targeting data, market intelligence and metrics to digital advertisers and publishers, online advertising and metrics,

The technology can be expanded to deliver real-time Amber Alerts on the web, become a trusted and secure repository of consumer choice and preferences, and applies to advertising, search, e-commerce, applications and content.

Targeting data can be generated from multiple sources of information and association and analytics of that data to provide the best possible combinations of the data, without compromising the privacy and identity of the consumer

Input data can be a combination of information: Directly generated and input by the consumer; Indirectly about the consumer which resides in the Consumer Relationship Management databases of the Internet or mobile service provider, with appropriate permission of the consumer; Technical information about the consumer, either on an individual or aggregate form that can be used for targeting; Subscription data and historical data about the user; Active and current data about a user, such as instantaneous mobile location, or how close the consumer is to reaching a certain level of use of their subscription plan; Active and current data about a user and their social network or community, such as exceeding a certain proximity or density of people in their network close to the current location, to trigger an invitation to meet or congregate; Types of data that can be collected, analyzed and collated, and then distributed to the licensed entities allows to use that data: Neighborhood (i.e. non-personally identifiable geo-location, such as postal code or zip code, or more accurate real-time location based on permission-based geolocation and historical travelled locations to determine a geo-social mapping of the user; Time/place/price/purpose/intent of the consumer expressed inside a portal, or derived from information directly or indirectly from the consumer's preferences; Network type (mobile, DSL, Cable etc) and Traffic type and volume (e.g. a heavy user of Internet in daytime, but light user on weekends), and Technical characteristics of the traffic (e.g. heavy video user, but little instant messaging or email); Subscription (e.g. user had DSL service but no mobile or IPTV) which allows a service provider or any other marketer to determine what type of advertising, up-sell/cross-sell opportunities are based on the known parameters of the user; What services and type of service such as Voice, internet, mobile, IPTV, Heavy user/light user of each of the communications services

The data can be used for Display advertising, Publisher content, Search optimization (e.g. hyper-local), E-commerce (e.g. selling certain goods on eBay to people in a similar socio-demographic category, given the common interests across these segments), targeted Video advertising and content, B2B ad campaigns on enterprise networks, where the metadata is related to the attributes of the enterprise not just a single user (e.g. traffic coming out of a real-estate office, or a local mechanic or plumber, versus a multinational agricultural chemicals company).

In addition to content and advertising, the metadata can be used for Applications customization (e.g. change attributes of applications to reflect time of day of user, or location of user, or demography of a user to match their style or interests)

In addition to conventional advertising, the metadata, associated with geo-demography and hyper-local information, and prior and even current polling information can be used to dynamically manage Political advertising to provide high yield and impact advertising on fixed and mobile networks

Groupon-like services at a hyper-local level or by location or intersection of consumer segmentation and locality (e.g. people close to a particular chain of providers of goods or services nationwide who fall into that particular geo-location area but also into the appropriate market segmentation)

Other applications (content customization for governmental and emergency services) such as Amber alerts/public service and Weather or natural disaster alerts

The collection and analytics on the metadata allows the system to create Metrics (audience intelligence) which is used to create and report Census-based metrics (temporal, spatial) and provide Ratings and audience measurement based on multiple parameters such as dynamic and historical traffic measurements segmented by geography, demography, age, income, etc across multiple publishers and ad networks, with a level of precision and accuracy that is not feasible with the inherent issues of over-counting and mis-estimation of traffic measurements due to cookie deletion, for example

The combination of collecting individual metadata, combined with metrics and reports, and correlated with actual publisher articles that are published, for example, on a sports or news site, and the associated measurements of an advertising campaign using the segmentation data allows for a level of Campaign Management for a brand or social or hyper-local advertiser that cannot be done with the fragmentation of tools, and disparity of tools used by different publishers, ad networks, exchanges, real-time bidders, data management platforms, and demand side platforms today. This also allows for combining offline data with online data to drive campaigns for Customer designated marketing areas (CDMAs) (macro/micro) and Franchise areas for certain goods and services.

One application of the invention is for management of traffic between different classes of users (including machines as well as people) inside an enterprise which may have one or more locations, and the destinations that they can communicate with, including other people inside or outside the enterprise, other machines inside and outside the enterprise and also controlled access to web content and applications and services based on the policies and compliance requirements of the enterprise

Since an enterprise has either machines or people who have certain permissions and policies that need to be enforced for purposes of confidentiality, compliance, financial policies (including legal or Sarbanes Oxley compliance or HIPPA)

Data loss (e.g. inadvertent transmission of information to unintended recipients, or deliberate attempts by a rogue employee to transmit information to an illicit destination) is a major concern at the egress point of an enterprise: current solutions are clumsy (i.e. difficult to examine large amounts of data) and inefficient

Issues such as Fraud prevention, Policy Management, Compliance, and Enterprise access control and verification can all be solved by inserting metadata in the http header traffic of a user's Internet connection.

For example: for all managers above VP level, the metadata contained in their traffic is different from sales clerks or analysts in the financial department. The enterprise router/server/switch in the company is used to insert metadata for each of the users in the network. The metadata and is recognized by the recipient of the metadata either in an intermediate server configured specifically for the purpose of policy and compliance management, or at the ingress point of another enterprise network, which filters, blocks and measures traffic, to ensure that the traffic complies with the corporate requirements.

This allows Geo-fencing and workforce management: i.e. certain classes of services and network access are permitted inside the enterprise and from certain devices, and not others. Similarly, certain levels of access are permitted inside a certain geographic area but not outside that area, to prevent inappropriate access to corporate information to a worker who is traveling outside their normal work regions.

In addition to enterprise controls, the invention also allows the enterprise to include metadata in their outbound traffic that can be used by internet destination sites for customization of content and advertising, similar to that covered in the Audience Intelligence section.

For example, an enterprise in a particular industry or service or trade can insert metadata into their traffic that signals to the internet destinations the general category of that enterprise, so that the content provider or advertiser is now aware that the incoming internet traffic is coming from inside an enterprise, and that the enterprise is a particular type of business.

As a result, the content publisher and advertiser can deliver information that is tailored for that type of company, rather than placing generic content or advertising on the device of the user

One application of the invention is for an Application for SmartGrid applications: SmartGrid covers a vast range of end point devices such as meter reading and remote sensing devices at various points in the electricity and other utility distribution grid

The addition of metadata to the traffic between the smartmeters in the smartgrid and the network gives a level of authentication and verification of the meters and their current status. The metadata can be generated both in the device and in the network (wireless or wired) to ensure that improper data is not generated inside the SmartGrid information systems (similar to the prevention of click-fraud in advertising systems, where anomalous amounts of information and traffic that cannot be accurately detected and prevented results in economic loss).

One application of the invention is for a trusted services based on a level of permission and protection which is managed as an added level of security and trust in cloud-based services, where not only at the commencement of a session, but either periodically or at certain trigger events, the client device is challenged, and invokes the addition of metadata to its traffic inside the network to provide a secondary and reliable way of assuring that the client device is legitimately using the cloud service.

Increasing use of cloud-based services imposes new requirements on authentication of a user, other than the simple use of username and password. The cloud service, when the user first begins to use the application, will not only register the username and password, but also communicate with the network(s) that the user utilizes to access the could service (enterprise, mobile, residential) and the credentials piggy-back on the credentials of that device accessing and authenticating on the network. Only the combination of the right user, device, and authenticated network access will permit the cloud service to be accessed.

One application of the invention is for a means of measuring, monitoring, and detecting threats from cybercriminals on an Internet network, by the active involvement of a mobile or fixed service provider network, where metadata is injected at the on-ramps of the internet, and any anomalous traffic detected in the path of the traffic or at strategically placed servers in the network can probe the network for these metadata.

Metadata in the communications service provider network provides a level of traceability that is not available today: the metadata, using dynamic generation of information, with timestamps and origination data, allows the network to sense, detect, monitor, alert and provide intelligence about anomalous traffic generation in the network, without the active knowledge of the consumer or enterprise, and also prevents the consumer or enterprise from blocking or somehow preventing detection, which is often done by spoofing IP addresses and MAC IDs and other types of identifiers in the network.

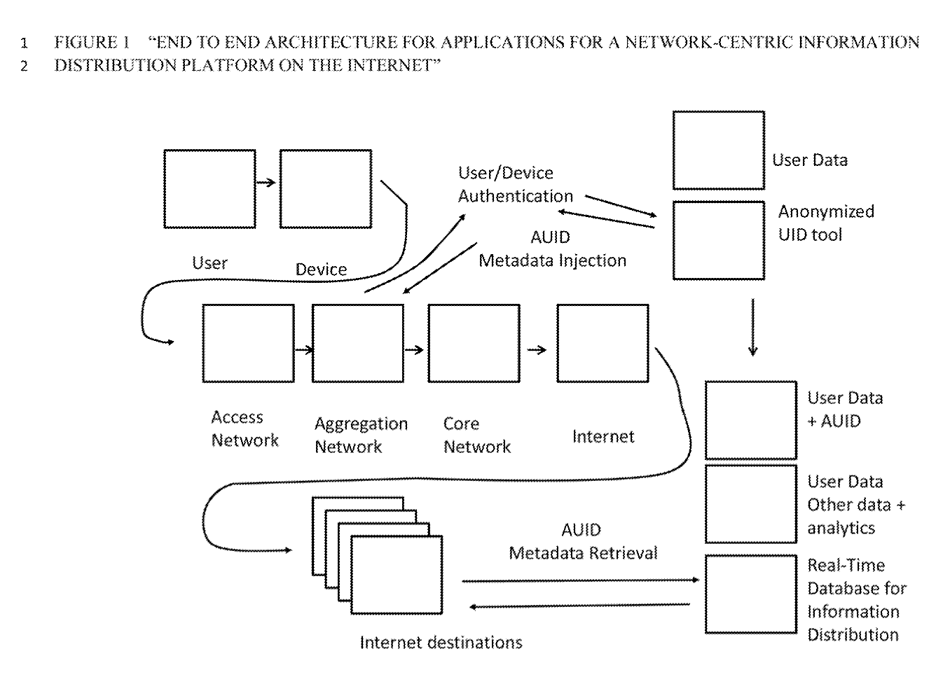

In FIG. 1, a user is a Consumer on a mobile or wired internet connection (or a combination), or A machine (such as SmartMeter in a SmartGrid) on an internet connection, or A remote sensor on internet connections, or A user on a mobile or fixed connection in a home, on the move, or in an enterprise.

in FIG. 1, a Device is a Computing or entertainment or educational or communications device With interface with the User, and a connection to a network, Where the network may be any form of wired and/or wireless connection, Including for consumer or enterprise connections to the Internet. Typically contains a browser or application or other mechanism for Initiating, authenticating and transmitting data to the network, Which also involves a process by which the unique attributes of that Device are authenticated by the network

in FIG. 1 Access Network is any form of wired or wireless access network, including either a consumer or enterprise network

in FIG. 1, an Aggregation Network is an Aggregation point for the service provider network, where the network is subscriber aware i.e. is tied to the authentication systems of the network) and is the point where the Anonymous User ID and metadata is injected into the traffic stream using software or hardware Implementation inside a router or switch or server or network appliance

in FIG. 1, the Core Network is the Transport and interconnections network of the communications service provider

in FIG. 1 the Internet describes the Traffic carried from the communications service provider network to All the web servers and destinations on the Internet

in FIG. 1, Internet Destinations include any webserver on the internet that provides a service such as Publishers, ad servers, search engines, social media networks, E-commerce, cloud services, content services etc.

in FIG. 1, User Data is Data associated with the specific user and or the device, Which is generated by a combination of information from the user, The device, customer data information inside the communications service provider's databases, And information generated by traffic and analytics performed inside the network By the communications service provider, such as service subscription data.

in FIG. 1, the Anonymized User ID Tool is an important tool that is used by the communications service provider To ensure the integrity and anonymity of any information that is exported out of their network, And also the formation of the metadata that is injected into the traffic stream, Containing certain extensible data fields, and in addition encryption of the metadata To prevent unintended disclosure of the user information by unauthorized recipients of the metadata

in FIG. 1, the Anonymized User ID and Metadata injection function is performed in the subscriber-aware part of the communications Service provider network (in a server, router, appliance or switch) and can be in Either a consumer mobile/broadband network or an enterprise network

in FIG. 1, the User Data+AUID is the combination of the AUID with the raw information that is gathered and Transmitted by the communications service provider to a database. This data is augmented with additional data that is from the combination of other types of data, analytics and resolved into various forms of Segmentation data that can be used for distribution to Internet destinations, in response to a query and interrogation of the data

in FIG. 1, the Real Time Database for Information Distribution is a database or a distributed database which holds the usable data Which is updated with information, and is made ready to respond in real-time To interrogations from Internet destinations for information for a particular User or device on the Internet. The information is only released when the Internet Destination provides the appropriate credentials, and is verified.

in FIG. 1, All these transactions are also captured in a way that accounting, Measurements, auditing and billing facilities are all in place, To ensure that there is end to end integrity of data transmission, And eliminating data leakage or loss in the process.

in a specific implementation of the invention, the user or machine initiates a request for service from a webserver using an http get request. Metadata is appended to the http get request either in the network or in the device or in some instances both, as there can be one or more additional pieces of metadata in the http get request.

that metadata is read by the webserver, and since the data is encrypted, the webserver can only utilize the metadata by presenting it to the real-time database for information distribution.

the realtime database for information distribution receives the metadata, matches it to information about that user based on the information contained in its database corresponding to that metadata which identifies that particular user and session, and returns the appropriate information to the webserver

the web server can then utilize that data to make decisions on what service it provides to the user, which could span any one of the applications described above, including many different examples, such as targeting content or advertising, providing assured opt-in or opt-out of certain services, blocking certain services in compliance of child protection requirements, verification, authentication and authorization of access to certain types of protected content and services, across one or more devices and subscription plans for both consumer and enterprise access control and management services.

other applications of the invention are for smartgrid, cloud and use of an aggregation of the metadata and their attributes not only to provide service customization, but to perform metrics and measurements and analytics of traffic patterns, such as how many of certain segments of attributes were active on a particular webserver at a particular time or location, with a level of robustness and accuracy that is not feasible with cookies and other counting tools on the web.

1. This invention claims a method comprising real-time generation and insertion of anonymized, encrypted and unique metadata for each http get request
in the network for a device such as a router, server or switch,
or in the device such as in the browser, application game or widget,
for a user or machine connecting to an internet network with a connected device
over wireless or wired connections for distribution to web servers on the internet
which are providing any form of web service including services such as content, advertising, security, commerce, management, enterprise business processes, search, social networking, and education, governmental or safely alerts.

2. This invention claims a method comprising collection, derivation, analysis and storage of information
for that particular device or user in the cloud or a server from one or more realtime and nonrealtime data sources which are aggregated into unique data attributes, classifications and segments,
while respecting the privacy of the user
and made available to any accredited web service that subscribes to the data service.

3. This invention claims a method comprising retrieval of the information for that particular device or user
from the cloud in realtime using the unique metadata by presenting credentials,
receiving the data, and customization of the service and experience for that user or machine based on that data,
and with the protections that the data cannot be misused or stored without the knowledge and permission of the cloud-based service,
so the service provided to the user or machine is tailored or customized According to the information revived for that internet service and session in progress.
